(19) United States
(12) Patent Application Publication
(10) Pub. No.: US 2012/0231211 A1
(43) Pub. Date: Sep. 13, 2012

(54) Method for the manufacture of a thermal barrier coating structure

(76) Inventors: Konstantin von Niessen, Buttwil (CH); Richard K. Schmid, Gerlikon (CH)

(21) Appl. No.: 13/330,752

(22) Filed: Dec. 20, 2011

(30) Foreign Application Priority Data
Dec. 21, 2010 (EP) 10196146.4

(51) Int. Cl. B05D 1/08; B32B 7/00

(52) U.S. Cl. 428/119; 427/448

(57) ABSTRACT

In the presented method for the manufacture of a thermal barrier coating structure (2) on a substrate surface (3) a ceramic coating material is applied onto the substrate surface by means of plasma spraying, wherein the thermal barrier coating structure includes at least two differently produced thermal barrier coatings (2.1, 2.2). For the manufacture of the one thermal barrier coating (2.1), the coating material is sprayed onto the substrate surface in the form of a powder jet by plasma spraying at atmospheric pressure (atmospheric plasma spraying or in abbreviation APS), and for the manufacture of the other thermal barrier coating (2.2) the coating material is applied onto the substrate surface by means of plasma spraying-physical vapor deposition or in abbreviation PS-PVD, such that a layer having elongate corpuscles develops on the substrate surface, which corpuscles form an anisotropic microstructure and are aligned essentially perpendicular to the substrate surface.

The invention relates to a method for the manufacture of a thermal barrier coating structure on a substrate surface in accordance with the preamble of claim 1 and to a substrate or work piece including a substrate surface having such a manufactured thermal barrier coating structure.

Thermal barrier coating systems are used in machines and processes to protect thermally heavily loaded parts with regard to the influence of heat, hot gas corrosion and erosion. Frequently an increase of the efficiency of machines and of processes is only possible on an increase of the process temperature so that exposed parts have to be correspondingly protected. For example, turbine blades or parts of the combustion chambers in aircraft engines and stationary gas turbines are thus normally provided with a single-layer thermal barrier coating or with a multi-layered thermal barrier coating system, to protect the turbine blades and/or parts of the combustion chambers against the influence of high process temperatures and to increase the maintenance intervals and their lifetime.

A thermal barrier coating system can include one or more layers in dependence on the application, for example a barrier layer, in particular a diffusion barrier layer, a bond layer, a hot gas corrosion protective layer, a protective layer, a thermal barrier coating and/or a cover layer. In the example of the above-mentioned turbine blades the substrate is generally made from a nickel alloy or from a cobalt alloy. The thermal barrier coating system applied on the turbine blade can, for example, include the following layers in increasing sequence:
a metallic barrier layer, for example, made of NiAl phases or of NiCr phases or alloys,
a metallic bond layer, which also serves as a hot gas corrosion protective layer and can, for example, be manufactured at least partly from a metal aluminid or an MCrAlY alloy, wherein M is one of the metals Fe, Ni or Co or a combination of Ni and Co,
an oxide ceramic protective layer, for example, of Al₂O₃ or of other oxides, an oxide ceramic thermal barrier coating, for example of stabilized zirconium oxide, and
an oxide ceramic smoothing layer or cover layer, for example of stabilized zirconium oxide or of SiO₂.

The oxide ceramic thermal barrier coating has the problem that due to the repeatedly occurring changes in temperature it has the tendency to form cracks which promote the spall off of the thermal barrier coating. For this reason the lifetime of the oxide ceramic thermal barrier coating was frequently unsatisfactory when thermal barrier coating systems were introduced on substrates which are thermally heavily loaded.

A thermal barrier coating system is known from the patent document U.S. Pat. No. 5,238,752, which includes an inter-metallic bond layer and a ceramic thermal barrier coating which has a columnar corn structure or microstructure. The columnar microstructure is manufactured by means of a vapor deposition technique which is known as electron beam-physical vapor deposition or in abbreviation EB-PVD-process in accordance with U.S. Pat. No. 5,238,752. The thereby manufactured thermal barrier coating has a considerably increased lifetime in comparison to the lifetime of a thermal barrier coating which has no columnar microstructure.

The manufacture of a thermal barrier coating system described in U.S. Pat. No. 5,238,752 has the disadvantage that the cost of the apparatus for the application of the thermal barrier coating by means of EB-PVD are comparatively high and that EB-PVD does not allow a “Non Line of Sight” (NLOS)-application of the thermal barrier coating while it is, for example, possible to also coat parts of the substrate which lie behind an edge and which are not visible from the plasma torch on low pressure plasma spraying (LPPS).

The document WO 03/087422 A1 discloses a low pressure, plasma spraying thin film process, by means of which thermal barrier coatings having a columnar microstructure can also be manufactured. The thermal barrier coatings manufactured with this method react to repeatedly arising temperature changes in a largely reversible manner, this means without the formation of cracks so that their lifetime is also considerably increased in comparison to the lifetime of thermal barrier coatings which have no columnar microstructure.

The plasma spray method described in WO 03/087422 A1 for the manufacture of thermal barrier coatings having a columnar structure is mentioned in conjunction with the LPPS-thin film process as it also uses a wide plasma jet which arises due to the pressure difference between the pressure in the interior of the plasma torch of typically 100 kPa and the pressure in the work chamber of less than 10 kPa. However, as the thermal barrier coatings manufactured with the described method are up to 1 mm thick or thicker and can thereby not be referred using the term “thin film”, the process described will be referred to in the following as plasma spray-physical vapor deposition—method or in abbreviation as PS-PVD-method.

However, the above described methods of manufacture for thermal barrier coatings having a columnar microstructure have the disadvantage that the manufacture is comparatively slow for thermal barrier coatings of 250 μm or thicker. For this reason the manufacture of thermal barrier coatings having a columnar microstructure is significantly more elaborate than the manufacture of thermal barrier coatings without such a microstructure.

It is the object of the invention to make available a method for the manufacture of a thermal barrier coating structure on a substrate surface which allows to reduce the effort in time and cost for the manufacture of the thermal barrier coating structure with regard to an equally thick conventional thermal barrier coating having columnar microstructure, without thereby impairing the thermal cycling resistance of the overall thermal barrier coating system. A further object of the invention consists of providing a substrate or a work piece including a substrate surface having such a thermal barrier coating structure.

These objects are satisfied in accordance with the invention by the method defined in claim 1 and the substrate or work piece defined in claim 10.

In the method for the manufacture of a thermal barrier coating structure on a substrate surface in accordance with the invention, a ceramic coating material is applied onto the substrate surface by means of plasma spraying, wherein the thermal barrier coating structure includes at least two differently produced thermal barrier coatings. For the manufacture of the one thermal barrier coating, the coating material is sprayed onto the substrate surface in the form of a powder jet by plasma spraying at atmospheric pressure (atmospheric plasma spraying or in abbreviation APS). For the manufacture of the other thermal barrier coating the coating material is applied onto the substrate surface in a work chamber at a pressure of less than 2000 Pa by means of plasma spraying - physical vapor deposition or in abbreviation PS-PVD, wherein the coating material is injected into a plasma as powder which plasma defocuses the powder jet and the powder is there evaporated partially or completely in that, for example, a plasma having a sufficiently high specific enthalpy is produced and typically a proportion of at least 10 or at least 20 weight percent of the coating powder is transformed into the vapor phase, so that a layer having elongate corpuscles develops on the substrate surface which corpuscles form an anisotropic microstructure and are aligned essentially perpendicular to the substrate surface. Such a microstructure is also referred to as a columnar microstructure.

The thermal barrier coating sprayed by means of APS can, for example, have a thickness of from 20 μm up to 1000 μm, or 50 μm up to 800 μm or 100 μm up to 600 μm and is sprayed in one or more layers. The thermal barrier coating applied by means of PS-PVD can have a thickness of from 20 μm up to 1000 μm or of 50 μm up to 800 μm or of 100 μm up to 600 μm and is advantageously applied in one or more layers.

In the case of multiple layers the individual layers of the thermal barrier coating sprayed by means of APS and/or the thermal barrier coating applied by means of PS-PVD can each have a thickness of from 3 μm up to 20 μm and, in particular each have a thickness of from 4 μm up to 12 μm.

Advantageously, a sequence of one or more thermal barrier coatings sprayed on by means of APS and one or more thermal barrier coatings applied by means of PS-PVD is generated.

In an advantageous variant the first thermal barrier coating on the substrate surface is a thermal barrier coating sprayed on by means of APS, and/or a thermal barrier coating sprayed on by means of APS is applied as an uppermost thermal barrier coating.

In an advantageous embodiment of the method, the ceramic coating material includes oxide ceramic components for the manufacture of the thermal barrier coatings, wherein the ceramic coating material is, for example, composed of stabilized zirconium oxide, in particular zirconium oxide stabilized with yttrium, cerium, gadolinium, dysprosium, or other rare earths and/or includes stabilized zirconium oxide as a component, in particular includes zirconium oxide stabilized with yttrium, cerium, gadolinium, dysprosium or other rare earths.

In a further advantageous embodiment of the method one or more of the following functional layers are additionally applied:
prior to the application of the thermal barrier coating, a metallic barrier layer having a thickness of from 2 μm up to 30 μm, in particular an inter-metallic barrier layer made of an alloy of NiAl or an alloy of NiCr or an alloy of PtAl or an alloy of PtNi,
prior to the application of the thermal barrier coating, a bond layer and/or a hot gas corrosion protective layer, in particular a layer having a thickness of from 50 μm to 500 μm of an alloy of the type MCrAlY where M=Fe, Co, Ni or NiCo,
prior to the application of the thermal barrier coating, a protective layer having a thickness of from 0.02 μm up to 20 μm or 0.3 μm up to 3 μm, in particular a protective layer of Al₂O₃ or of a ternary Al—Zr—O compound,
following the application of the thermal barrier coating, a smoothing layer, in particular a smoothing layer of from 2 μm up to 50 μm thickness of oxide ceramic coating material and/or from the same coating material as the thermal barrier coatings.

Advantageously at least two plasma spray systems are provided for the manufacture of the thermal bearing coating structure: an apparatus for spraying thermal barrier coatings by use of APS and an apparatus for applying thermal barrier coatings by means of PS-PVD.

The invention further includes a substrate or a work piece including a substrate surface having a thermal barrier coating structure which is manufactured in accordance with a method in accordance with one or more of the above described embodiments and variants, wherein the thermal barrier coating structure includes at least two differently produced thermal barrier coatings, namely a thermal barrier coating sprayed on by means of APS and a thermal barrier coating applied by means of PS-PVD, wherein the thermal barrier coating applied by means of PS-PVD includes elongated corpuscles forming an anisotropic microstructure and which are aligned essentially perpendicular to the substrate surface.

The method for the manufacture of a thermal barrier coating structure on a substrate surface in accordance with the present invention and the substrate or the work piece having such a thermal barrier coating structure, have the advantage that due to the use of APS for spraying a part of the thermal barrier coating system, the effort in time and cost for the manufacture of the same can be reduced with regard to common thermal barrier coatings exclusively manufactured by means of PS-PVD having the same thickness, without influencing the thermal cycling resistance of the overall thermal barrier coating system.

The above descriptions of embodiments and variants merely serve as an example. Further advantageous embodiments emerge from the dependent claims and the drawing. Furthermore, individual features from the described embodiments and variants or features from the embodiments and variants shown can also be combined with one another to form new embodiments in the scope of the present invention.

In the following the invention will be described in detail with regard to the embodiments and with reference to the drawing. There is shown:

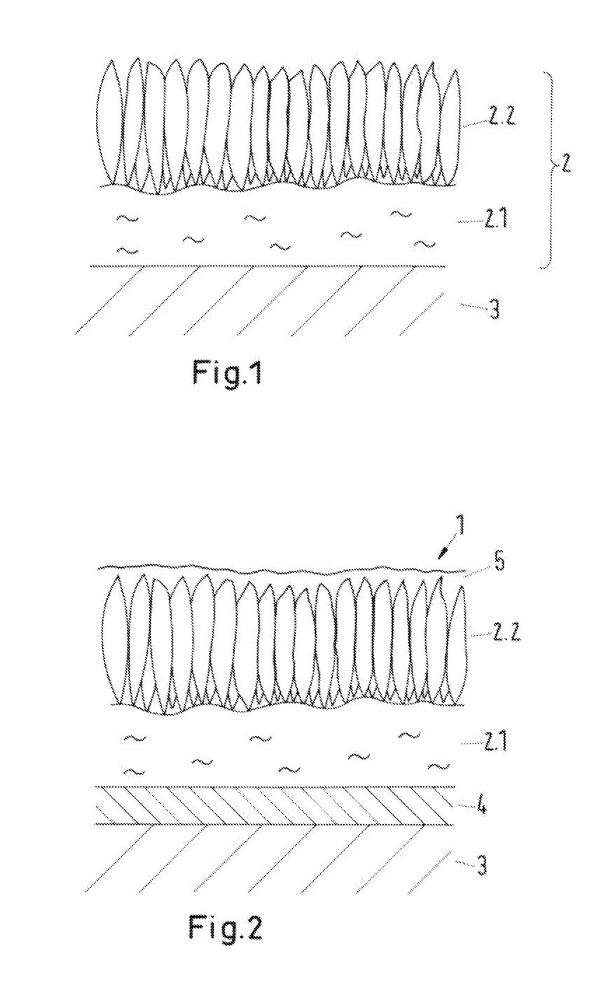

FIG. 1 an embodiment of a thermal barrier coating structure manufactured in accordance with the present invention, and

FIG. 2 an embodiment of a thermal barrier coating system having a thermal barrier coating structure manufactured in accordance with the present invention.

An embodiment of the method for the manufacture of thermal barrier coating structure 2 on a substrate surface 3 in accordance with the invention will be described in the following with reference to FIG. 1. In the method a ceramic coating material is applied onto the substrate surface by means of plasma spraying, wherein the thermal barrier coating system 2 includes at least two differently produced thermal barrier coatings 2.1, 2.2. For the manufacture of the one thermal barrier coating, the coating material is sprayed onto the substrate surface in the form of a powder jet by plasma spraying at atmospheric pressure (Atmospheric Plasma Spraying or in abbreviation APS). For the manufacture of the other thermal barrier coating 2.2, the coating material is applied onto the substrate surface in a work chamber at a pressure of less than 2000 Pa, by means of Plasma Spraying-Physical Vapor Deposition or in abbreviation PS-PVD, wherein the coating material is injected into a plasma as powder which plasma defocuses the powder jet and the powder is there evaporated partially or completely in that, for example, a plasma having a sufficiently high specific enthalpy is produced and a portion of at least 10 or at least 20 weight percent of the coating powder is transferred into the vapor phase, so that a layer having elongate corpuscles develops on the substrate surface which corpuscles form an anisotropic microstructure and are aligned essentially perpendicular to the substrate surface. Such a microstructure is also referred to as a columnar microstructure.

For the manufacture of the APS thermal barrier coating 2.1 a plasma spray apparatus for atmospheric plasma spraying with a plasma torch can be used, for example, a DC plasma torch of the type 9 MB of the company Sulzer Metco can be used. The electric power supplied to the plasma torch during the plasma spraying typically amounts to from 40 kW up to 80 kW. A mixture of Ar and selectively He and/or H₂ can be used as a plasma gas, for example, Ar having 30% to 40% He or H₂ can be used.

For the manufacture of the PS-PVD thermal barrier coating 2.2 a plasma coating apparatus is expediently used which has a work chamber having a plasma torch for the manufacture of a plasma jet, a pump apparatus which is connected to the work chamber to lower the pressure of the work chamber to 2000 Pa or less and which has a substrate holder for holding the substrate. The plasma torch, which can, for example, be configured as a DC plasma torch, can advantageously be supplied with electric power of at least 60 kW, 80 kW or 100 kW to produce a plasma with a sufficiently high specific enthalpy so that thermal barrier coatings having a columnar microstructure can be manufactured. The plasma coating apparatus can additionally include one or more injection devices to inject one or more components in solid, liquid and/or gas-like shape into the plasma or into the plasma jet, as required.

The plasma torch is typically connected to a power supply for the manufacture of the PS-PVD thermal barrier coating, for example, a DC power supply for a DC plasma torch, and/or to a cooling apparatus and/or to a plasma gas supply and, as the case may be, to a supply for liquid and/or gas-like reactive components and/or to a supply device for spray powder or suspension. The process gas or plasma gas can, for example, contain argon, nitrogen, helium and/or hydrogen or a mixture of an inert gas with nitrogen and/or hydrogen and/or be made of one of more of these gases.

Advantageously the substrate holder is carried out as a displaceable rod holder to move the substrate from a pre-chamber into the work chamber through a sealing lock. The rod holder additionally enables the rotation of the substrate during the treatment and/or coating if required.

Furthermore, the plasma coating apparatus for the manufacture of the PS-PVD thermal barrier coating can additionally include a controlled displacement apparatus for the plasma torch to control the direction of the plasma jet and/or the distance from the plasma torch to the substrate surface 3, for example in a region of from 0.2 m up to 2 m or of 0.3 m up to 1.2 m. From case to case, one or more pivot axes can be provided in the displacement apparatus to carry out pivot movements. Moreover, the displacement apparatus can additionally also include linear displacement axes, to arrange the plasma torch above different regions of the substrate surface 3. Linear movements and pivot movements of the plasma torch allow a control of the substrate treatment and of the substrate coating, for example, to uniformly pre-heat a substrate surface or to achieve a uniform layer thickness and/or layer quality on the substrate surface.

The thermal barrier coating 2.1 sprayed by means of APS can, for example, have a thickness of from 20 μm up to 1000 μm or of 50 μm up to 800 μm or of 100 μm up to 600 μm and can be sprayed in one or more layers. The thermal barrier coating 2.2 applied by means of PS-PVD can have a thickness of from 20 μm up to 1000 μm or of from 50 μm up to 800 μm or of from 100 μm up to 600 μm and is advantageously applied in a plurality of layers.

In the case of several layers the individual layers of the thermal barrier coating 2.1 sprayed by means of APS and/or the thermal barrier coatings 2.2 applied by means of PS-PVD each have a thickness of from 3 μm up to 20 μmm, in particular each can have a thickness of from 4 μm up to 12 μm.

Advantageously, a sequence of one or more thermal barrier coatings sprayed on by means of APS and one or more thermal barrier coatings applied by means of PS-PVD is/are generated.

In an advantageous variant the first thermal barrier coating on the substrate surface 3 is a thermal barrier coating sprayed on by means of APS and/or a thermal barrier coating sprayed on by means of APS is applied as the uppermost thermal barrier coating.

In an advantageous embodiment of the method the ceramic coating material for the manufacture of the thermal barrier coatings 2.1, 2.2 includes oxide ceramic components, wherein the ceramic coating material, for example, is composed of stabilized zirconium oxide, in particular zirconium oxide stabilized with yttrium, cerium, gadolinium, dysprosium or other rare earths and/or includes stabilized zirconium oxide as a component, in particular includes zirconium oxide stabilized with yttrium, cerium, gadolinium, dysprosium or other rare earths, wherein the yttrium oxide content is typically between 5 to 20 weight % in the case of yttrium stabilized zirconium oxide.

The powder-shaped starting material has to be very finally granulated so that the powder jet is transformed into a cloud of vapor by the defocusing plasma from which a layer having the desired columnar structure results during the manufacture of the PS-PVD thermal barrier coating 2.2. A substantial stantial part of the size distribution of the starting material advantageously lies in the range of between 1 μm and 50 μm, preferably of between 1 μm and 25 μm.

One or more functional layers are additionally applied onto the thermal barrier coating in a further embodiment of the method in accordance with the invention for the manufacture of a thermal barrier coating structure on a substrate surface 3. The embodiment will be described in the following with reference to FIG. 2. A ceramic coating material is applied onto the substrate surface by means of plasma spraying in this embodiment, wherein the thermal barrier coating structure includes at least two differently produced thermal barrier coatings 2.1, 2.2. For the manufacture of the one thermal barrier coating 2.1 the coating material is sprayed onto the substrate surface in the form of a powder jet by plasma spraying at atmospheric pressure (Atmospheric Plasma Spraying or in abbreviation APS). For the manufacture of the other thermal barrier coating 2.2, the coating material is applied onto the substrate surface in a work chamber having a pressure of less than 2000 Pa by means of Plasma Spraying-Physical Vapor Deposition or in abbreviation PS-PVD, wherein the coating material is injected into a plasma as powder which plasma defocuses the powder jet and the powder is there evaporated partially or completely in that, for example, a plasma having a sufficiently high specific enthalpy is generated and a proportion of at least 10 or at least 20 weight percent of the coating powder is transferred into the vapor phase, so that a layer having elongate corpuscles develops on the substrate surface, which corpuscles form an anisotropic microstructure and are aligned essentially perpendicular to the substrate surface.

Possible embodiments and variants, as well as more precise statements with regard to the manufacture of thermal barrier coatings can be obtained from the description of the first embodiment above which was exemplified with reference to FIG. 1.

In the following embodiment one or more of the following functional layers are applied in addition to the thermal barrier coating:
prior to the application of the thermal barrier coating, a metallic barrier layer having a thickness of from 2 μm up to 30 μm, in particular an inter-metallic barrier layer made of an alloy of NiAl or an alloy of NiCr or an alloy of PtAl or an alloy of PtNi,
prior to the application of the thermal barrier coating a bond layer and/or a hot gas corrosion protective layer 4, in particular a layer of 50 μm to 500 μm thick of an alloy of the type MCrAlY where M=Fe, Co, Ni or NiCo,
prior to the application of the thermal barrier coating a protective layer of from 0.02 μm up to 20 μm or of from 0.3 μm up to 3 μm thickness, in particular a protective layer of Al₂O₃ or of a ternary Al—Zr—O compound,
following the application of the thermal barrier coating a smoothing layer 5 in particular a smoothing layer of from 2 μm up to 50 μm thickness of oxide ceramic coating material and/or from the same coating material as the thermal barrier coatings.

The thermal barrier coatings 2.1, 2.2 in combination with the above-described functional layers are also referred to as the thermal barrier coating system 1.

The metallic barrier layer mentioned is of advantage when the substrate surface is not formed by an alloy on the basis of NiAl. In this case the metallic barrier layer is directly applied onto the substrate surface 3 and serves to prevent a preliminary degradation of the subsequently applied bond layer and/or hot gas corrosion protective layer 4.

A protective layer is typically additionally applied onto the bond layer and/or the hot gas corrosion protective layer 4, as mentioned above, which is expediently formed as an oxide layer. The oxide layer can, for example, be manufactured in the work chamber of the plasma coating apparatus which is used for the manufacture of the PS-PVD thermal barrier coating 2.2. The oxide layer can, for example, be thermally produced in that the substrate surface is, for example, heated by the plasma jet, wherein the work chamber includes oxygen or a gas including oxygen during the manufacture of the oxide layer.

The oxide layer, which is used as a protective layer, advantageously has a porosity of less than 2% or of less than 0.5% or of less than 0.1% in that, for example the protective layer is essentially formed from Al₂O₃.

If required the barrier layer and/or the bond layer and/or the hot gas corrosion protective layer 4 and/or the protective layer can be produced in the work chamber of the plasma coating plant which is used for the manufacture of the PS-PVD thermal bearing coating 2.2.

In a further advantageous embodiment the direction of the plasma jet and/or the distance of the plasma torch from the substrate can be controlled. Thereby, the plasma jet can, for example, on heating of the substrate surface and/or on production of the oxide layer and/or on applying the thermal barrier coatings 2.1, 2.1 be guided over the substrate surface to achieve an as uniform as possible treatment or coating and to avoid possible local heating and/or damage of the substrate surface and/or the substrate which can arise with a constantly directed plasma jet at high beam powers.

Prior to the application and/or the generation of the coatings described in the embodiments and variants above the substrate and/or the substrate surface 3 is normally preheated to improve the adhesion of the layers. The pre-heating of the substrate can occur by means of the plasma jet, wherein it is normally sufficient to guide the plasma jet over the substrate by means of a few pivot movements which plasma jet does not include coating powder or reactive components for the pre-heating. Typically 20 to 30 pivot movements are sufficient to heat the substrate surface 3 to a temperature of from 800° C. up to 1300° C.

Independent of the plasma spray method used, it can be advantageous to use an additional heat source to carry out the application and/or the generation of the thermal barrier coatings and functional layers within a predetermined temperature region as are described in the embodiments and variants above. The temperature is expediently predefined in the range between 800 and 1300° C., preferably in a temperature range of >1000° C. For example, an infrared lamp and/or a plasma jet and/or a plasma can be used as an additional heat source. In this respect the heat supply of the heat source and/or the temperature of the substrate to be coated are controlled or regulated.

At least two plasma spray apparatuses are advantageously provided for the manufacture of the thermal barrier coating structure: an apparatus for the spraying of thermal barrier coatings by means of APS and an apparatus for applying thermal barrier coatings by means of PS-PVD.

The invention further includes a substrate or a work piece including a substrate surface having a thermal barrier coating structure manufactured according to a method in accordance with one or more of the embodiments and variants described above. FIG. 1 shows an embodiment of the thermal barrier coating structure 2 in accordance with the present invention and FIG. 2 shows an embodiment of a thermal barrier coating system 1 having a thermal barrier coating structure in accordance with the present invention. The thermal barrier coating structure includes at least two differently manufactured thermal barrier coatings 2.1, 2.2 in both embodiments, namely a thermal barrier coating 2.1 sprayed by means of APS and a thermal barrier coating 2.2 applied by means of PS-PVD, wherein the thermal barrier coating applied by means of PS-PVD includes elongate corpuscles which form an anisotropic microstructure and which are aligned essentially perpendicular to the substrate surface.

In the embodiments shown the thermal barrier coating structure is applied onto a substrate surface 3 of the substrate or work piece. In a typical variant, the substrate and/or the work piece and/or the substrate surface are metallic, wherein the substrate and/or the work piece can, for example, be a turbine blade made of a Ni alloy or of a Co alloy.

In the embodiment shown in FIG. 2 a bond layer and/or a hot gas corrosion protective layer 4 is additionally provided between the substrate and the thermal barrier coatings 2.1, 2.2, for example, a layer of a metal aluminid such as NiAl or PtAl or an alloy of the type MCrAlY where M=Fe, Co, Ni or a combination of Ni and Co. The bond layer and/or the hot gas corrosion protective layer 4 typically has a thickness of between 50 μm and 500 μm. As required,
a barrier layer of typically 2 μm to 30 μm thickness can be additionally provided between the substrate and the bond layer and/or the hot gas corrosion protective layer 4 (not shown in FIG. 2), wherein the barrier layer is advantageously formed from metal, for example, in the form of an inter-metallic barrier layer made of an alloy of NiAl or an alloy of NiCr or the alloy of PtAl or the alloy of PtNi, and/or
a protective layer of 0.02 μm up to 20 μm or of 0.03 μm up to 3 μm thickness can be additionally provided between the bond layer and/or the hot gas corrosion protective layer 4 and/or the thermal barrier coatings 2.1, 2.2 (not shown in FIG. 2), wherein the protective layer is advantageously formed as an oxide layer, for example, in the form of a protective layer of Al₂O₃ or of a ternary Al—Zr—O compound.

The application of the locking barrier and/or the bond layer and/or the hot gas corrosion protective layer and/or the protective layer can, if desired, take place in the framework of the method for the manufacture of a thermal barrier coating structure. In an advantageous embodiment the barrier coating and/or the bond layer and/or the hot gas corrosion protective layer 4 and/or the protective layer are initially applied onto the substrate surface 3, for example by means of a plasma spray method or by means of a different suitable method and the thermal barrier coating structure is continued in that at least two differently produced thermal barrier coatings 2.1, 2.2 are applied.

As required, as shown in FIG. 2, an additional smoothing layer 5 can be provided on the uppermost thermal barrier coating which, for example, is made of an oxide ceramic material such as ZrO₂ or SiO₂ and has a thickness of typically 1 μm up to 50 μm, preferably of 2 μm up to 20 μm. Frequently, the smoothing layer is made of the same coating material as the thermal barrier coatings. The smoothing layer can be applied by means of PS-PVD or APS in that, for example, one or more components are injected into the plasma or into the plasma jet in solid, liquid and/or gas-like form.

The above described method for manufacture of a thermal barrier coating structure on a substrate surface, the associated embodiments and variants as well as substrate or work piece with such a manufactured thermal barrier coating structure have the advantage that a thermal barrier coating structure manufactured with the described method can be manufactured cheaper with regard to an equally thick common thermal barrier coating having a co-lumnar microstructure without the thermal cycling resistance of the overall thermal barrier coating system being influenced thereby.

1. A method for the manufacture of a thermal barrier coating structure on a substrate surface, wherein a ceramic coating material is applied onto the substrate surface by means of plasma spraying, characterized in that the thermal barrier coating structure includes at least two differently produced thermal barrier coatings, wherein, for the manufacture of the one thermal barrier coating, the coating material is sprayed onto the substrate surface in the form of a powder jet by plasma spraying at atmospheric pressure (atmospheric plasma spraying or in abbreviation APS), and wherein, for the manufacture of the other thermal barrier coating the coating material is applied onto the substrate surface in a work chamber at a pressure of less than 2000 Pa by means of plasma spraying-physical vapor deposition or in abbreviation PS-PVD, wherein the coating material is injected into a plasma as powder which plasma defocusses the powder jet and the powder is there evaporated partially or completely so that a layer having elongate corpuscles develops on the substrate surface, which corpuscles form an anisotropic microstructure and are aligned essentially perpendicular to the substrate surface.

2. A method in accordance with claim 1, wherein the thermal barrier coating sprayed on by means of APS has a thickness of from 20 μm up to 1000 μm and is sprayed in one or more layers.

3. A method in accordance with claim 1, wherein the thermal barrier coating applied by means of PS-PVD has a thickness of from 20 μm up to 1000 μm, and is applied in one or more layers.

4. A method in accordance with any claim 1, wherein the individual layers of the thermal barrier coating sprayed on by means of APS and/or of the thermal barrier coating applied by means of PS-PVD each have a thickness of from 3 μm up to 20 μm.

5. A method in accordance with claim 1, wherein a sequence of one or more thermal barrier coatings sprayed on by means of APS and one or more thermal barrier coatings applied by means of PS-PVD is generated.

6. A method in accordance with claim 1, wherein the first thermal barrier coating on the substrate surface is a thermal coating barrier sprayed on by means of APS, and/or wherein a thermal barrier coating sprayed on by means of APS is applied as the uppermost thermal barrier coating.

7. A method in accordance with claim 1, wherein the ceramic coating material includes oxide ceramic components for the manufacture of the thermal barrier coatings, and/or wherein the ceramic coating material for the manufacture of the thermal barrier coatings is composed of stabilized zirconium oxide, in particular zirconium oxide stabilized with yttrium, cerium, gadolinium, dysprosium, or other rare earths and/or includes stabilized zirconium oxide as a component, in particular includes zirconium oxide stabilized with yttrium, cerium, gadolinium, dysprosium or other rare earths.

8. A method in accordance with claim 1, wherein one or more of the following functional layers are additionally applied:
prior to the application of the thermal barrier coating a metallic barrier layer, in particular an intermetallic barrier layer having a thickness of from 2 μm up to 30 μm and made of an alloy of NiAl or an alloy of NiCr, or an alloy of PtAl or an alloy of PtNi,
prior to the application of the thermal barrier coating a bond layer and/or a hot gas corrosion protective layer 4, in particular a layer 50 μm to 500 μm thick of an alloy of the type MCrAlY where M=Fe, Co, Ni or NiCo,
prior to the application of the thermal barrier coating an oxide ceramic protective coating, in particular a protective layer of from 0.02 μm up to 20 μm or 0.03 μm up to 3 μm thickness of Al₂O₃ or of a ternary Al—Zr—O compound,
following the application of the thermal barrier coating a smoothing layer 5, in particular a smoothing layer of from 2 μm up to 50 μm thickness of oxide ceramic coating material and/or from the same coating material as the thermal barrier coatings.

9. A method in accordance with claim 1, wherein at least two plasma spray systems are provided for the manufacture of the multilayer thermal barrier system: an apparatus for spraying thermal barrier coatings by means of APS and an apparatus for applying thermal barrier coatings by means of PS-PVD.

10. A substrate or a workpiece including a substrate surface having a thermal barrier coating structure manufactured using a method in accordance with claim 1, which includes at least two differently produced thermal barrier coatings, namely a thermal barrier coating sprayed on by means of APS and a thermal barrier coating applied by means of PS-PVD, wherein the thermal barrier coating applied by means of PS-PVD includes elongated corpuscles which form an anisotropic microstructure and which are aligned essentially perpendicular to the substrate surface.

11. A method in accordance with claim 1, wherein the thermal barrier coating sprayed on by means of APS has a thickness of from 50 μm up to 800 μm, and is sprayed in one or more layers.

12. A method in accordance with claim 1, wherein the thermal barrier coating applied by means of PS-PVD has a thickness of from 50 μm up to 800 μm and is applied in one or more layers.

13. A method in accordance with claim 1, wherein the individual layers of the thermal barrier coating sprayed on by means of APS and/or of the thermal barrier coating applied by means of PS-PVD each have a thickness of from 4 μm up to 12 μm.
